(19) United States
(12) Patent Application Publication
(10) Pub. No.: US 2008/0047096 A1
(43) Pub. Date: Feb. 28, 2008

(54) Doorstop and holder

(76) Inventor: John C. Pistone, Ft. Lauderdale, FL (US)

Correspondence Address: ROBERT M. DOWNEY, P.A., 6751 N. FEDERAL HWY., SUITE 300, BOCA RATON, FL, 33487, US

(21) Appl. No.: 11/801,161

(22) Filed: May 8, 2007

Related U.S. Application Data
(60) Provisional application No. 60/840,323, filed on Aug. 25, 2006.

(51) Int. Cl. E05F 5/02

(52) U.S. Cl. 16/82

(57) ABSTRACT

A doorstop and holder is formed as a one-piece integral unit and includes a base that is adapted for mounting to a floor surface and a pair of arms extending outwardly from opposite side abutment faces of the base. The side faces are sized and positioned for abutting engagement with the lower end of the door to prevent the door from hitting an adjacent wall upon opening. Enlarged heads on the end of each arm hold the door open to prevent unwanted slamming of the door due to external forces, such as wind. The opposite arms allow the device to be used for both left swinging and right swinging doors. A further embodiment provides a mounting base adapter for mounting the doorstop and holder to a finished floor surface, such as tile or marble.

### BACKGROUND OF THE INVENTION

1. Field of the Invention

This invention relates to doorstops and, more particularly, to a combined doorstop and door holder that mounts to a floor surface and releasably holds a door in an open position when the door swings open against the doorstop.

2. Discussion of the Related Art

A wide variety of doorstops are well known in the art for preventing damage to a door and an adjacent wall when the door swings open. For the most part, doorstops are mounted to either the floor or the wall surface that the door would otherwise hit when swinging to the full open position. In either instance, the doorstop is provided with a bumper surface for abutting engagement with the door.

It has also been proposed in the art to combine a doorstop with a door retaining structure that holds the door open. Examples of combination doorstop and retainer devices are disclosed in the U.S. Patents to Lefebvre, U.S. Pat. No. 5,226,201; Pool, U.S. Pat. No. 4,134,608; Von Berg, U.S. Pat. No. 2,784,443; Kamerschen, U.S. Pat. No. 6,016,588; Delanie Jr., U.S. Pat. No. 5,082,317; and Troy U.S. Pat. No. 5,575,514.

One particular environment where a combined doorstop and door holder is needed is in a high-rise building that is under construction. In many instances, the interior doors are installed during the construction of a high-rise building prior to the installation and/or activation of the air-conditioning systems throughout the building. Under these circumstances, it is common for construction workers to open sliding glass doors or windows for cross ventilation. However, the wind forces of the cross breeze passing through the interior of the building, as a result of opening multiple exterior glass doors and/or windows, often cause the interior doors to violently slam open and closed. This causes severe damage to the interior doors, the door frames and the walls adjacent to the doors.

Accordingly, there is an urgent need for a combined doorstop and door holder device that automatically holds doors in their open position when doors swing open and against the doorstop, and that further allows the door to be easily released from the held open position with the touch of a foot or finger. More particularly, there is a need for a combined doorstop and door holder device that is adapted for temporary use in a high-rise building during construction to prevent damage to interior doors, door frames and walls. A device of this nature needs to be adapted for easy and quick installation to either a rough floor surface (e.g. a concrete deck) or a tile or marble floor. The combined doorstop and door holder device should also be readily adapted for both left swinging and right swinging doors. Finally, a combined doorstop and door holder device for temporarily use during a construction of a high-rise building needs to be of a simple, integral design to reduce cost and simplify installation and removal. While the above referenced patents disclose combined doorstop and holder devices of various types, they all fail to address these needs, particularly for temporary use in a high-rise building under construction.

### SUMMARY OF THE INVENTION

The present invention is directed to a doorstop and holder device that is intended for temporary installation during the construction of a high-rise building. The device includes a base that is adapted for mounting to a floor surface and a pair of arms extending outwardly from opposite side abutment faces of the base. The side faces are sized and positioned for abutting engagement with the lower end of the door to prevent the door from hitting an adjacent wall upon opening. Enlarged heads on the end of each arm hold the door open to prevent unwanted slamming of the door due to external forces, such as wind. The opposite arms allow the device to be used for both left swinging and right swinging doors.

In one embodiment, the base is temporarily fastened to a rough (unfinished) floor surface with the use of a threaded fastener, such as a concrete screw, that passes down through the base and into the underlying deck.

In another embodiment, a separate mounting adapter is provided for mounting the doorstop and holder device to a finished floor surface, such as tile or marble. The adapter is provided with a double-sided adhesive membrane on its bottom surface for bonding attachment to the finished floor surface. The adapter is structured for receiving the doorstop and holder device thereon. Screw fasteners are used to secure the doorstop and holder device on the adapter.

### BRIEF DESCRIPTION OF THE DRAWINGS

For a fuller understanding of the nature of the present invention, reference should be made to the following detailed description taken in conjunction with the accompanying drawings in which:

FIG. 1 is a top perspective view of the doorstop and holder device of the present invention;

FIG. 2 is a top plan view of the doorstop and holder device;

FIG. 3 is a side elevational view of the doorstop and holder device;

FIG. 4 is a top plan view showing the doorstop and holder device in use with a door swung open and held open by the device;

FIG. 5 is an exploded view showing the doorstop and holder device separated from a tile and marble mounting adapter that is structured for attachment of the doorstop and holder device thereto; and

FIG. 6 is a top plan view of the tile and marble mounting adapter.

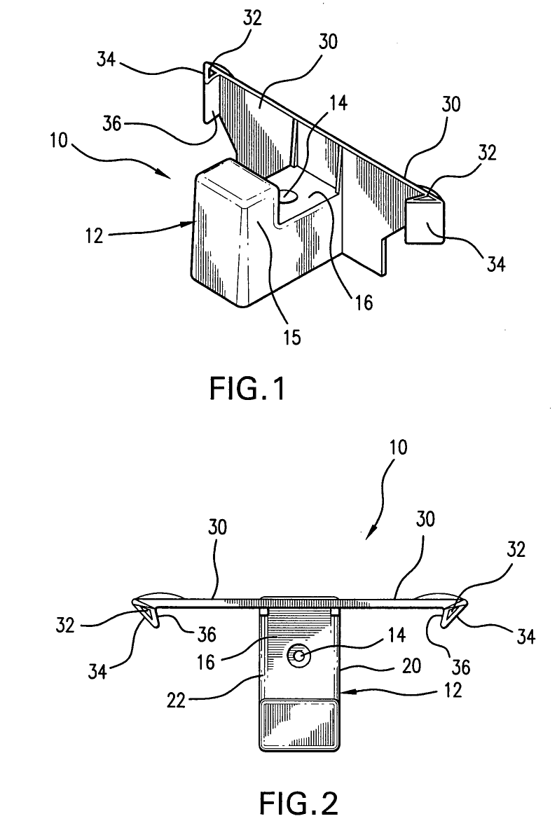

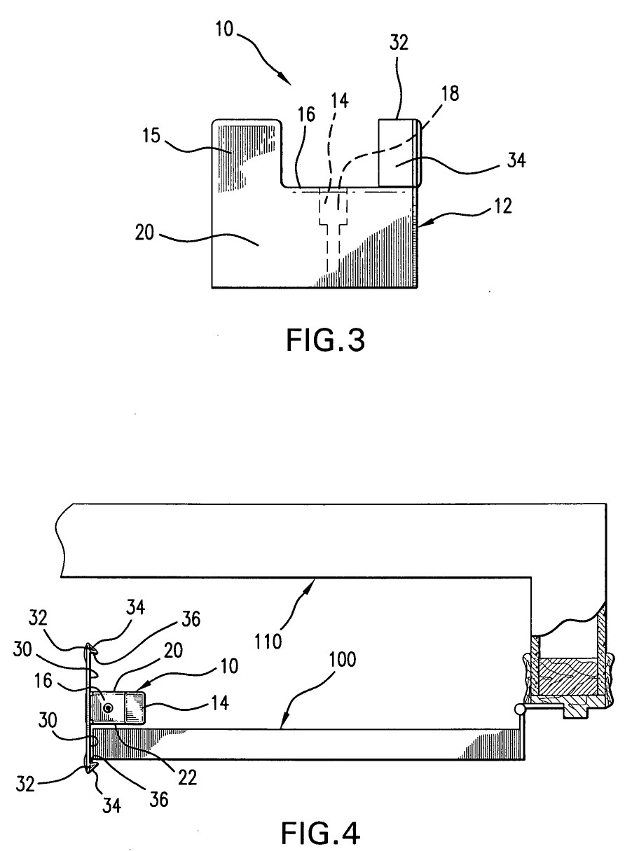

Like reference numerals refer to like parts throughout the several views of the drawings.

### DETAILED DESCRIPTION OF THE PREFERRED EMBODIMENT

The present invention is directed to a combined doorstop and door holder device, generally indicated as 10, that is particularly suited as a temporary aid during door installation and construction in a high-rise building to prevent interior doors from violently slamming closed as a result of wind forces (e.g., as a result of cross breeze ventilation).

The combined doorstop and holder device 10 is formed as a one-piece integral unit and includes a base 12 that is adapted for temporary mounting to a rough floor surface (e.g., concrete slab) with the use of a conventional fastener, such as a TAPCON concrete screw. A hole 14 is formed through the top side 16 of the base for passage of the fastener therethrough and into the underlying deck surface. When fully inserted and fastened, the head of the fastener becomes seated against the base, and preferably within a counter-sunk bore 18 that extends down into the base. The hole 14 is positioned to minimize the tendency of the base to turn or twist in response to external forces applied to the sides, such as when a swinging door strikes the base. The doorstop and holder further includes oppositely disposed arms 30 that extend outwardly and perpendicularly to opposite side faces 20, 22 of the base 12. An enlarged head 32 formed on the end of each arm has a tapered frontal surface 34 and a rear surface that forms an abrupt shoulder 36. The ends of the arms are reinforced with increased thickness to discourage cracking or breaking when the arms 30 flex and bend in yielding to the force of a door hitting the tapered frontal surfaces 34 of the heads 32. The proximal portions of the arms 30 are provided with increased height, extending to the bottom of the device 10. This further strengthens the arms 30.

The opposite side faces 20, 22 of the base 12 provide an abutment surface for stopping the door 100 before the door or door hardware hit an adjacent wall surface 110. As the door 100 swings open, the lower side edge of the door eventually approaches the doorstop and holder device 10 that is mounted to the floor. The first contact of the door 100 with the device 10 is against the tapered frontal surface 34 of the enlarged head 32 on one of the opposite arms. The tapered frontal surface 34 allows the door to continually swing open, as the lower side edge of the door brushes against the tapered surface on the end of the arm 30. The arms 30 are relatively rigid and resilient, but will flex slightly when yielding to the force of the door brushing against the tapered surface. Once the edge of the door 100 clears the tapered surface, the door continues to move open until it eventually hits the side abutment face 20 or 22 of the base. At this point, the door cannot return to the closed position due to abutting engagement with the abrupt shoulder 36 on the enlarged head. Accordingly, the door is releasably captivated in an open position between the abrupt shoulder 36 and the abutment face 20 or 22 of the base. The taller portion 15 of the base provides higher abutment side faces to accommodate for large clearances between the slab surface and the bottom of the door. This is a common situation that exists before marble or stone is installed on the slab floor surface. The higher abutment face allows the door to hit the base in this instance. The door can be released from the captivated open position by flexing the arm 30 until the shoulder on the rear side of the head is clear from the swinging path of the lower side edge of the door, thereby allowing the door to be swung closed.

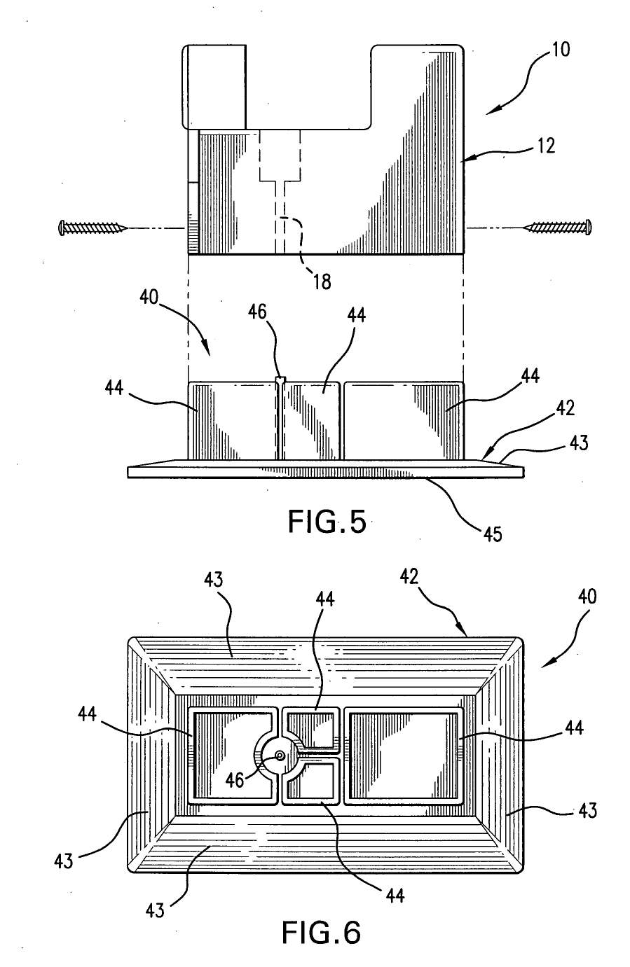

Referring to FIGS. 5 and 6, a further embodiment of the invention includes a mounting adapter 40 for mounting the doorstop and holder device 10 to a finished floor surface, such as tile or marble. The adapter 40 allows attachment of the doorstop and holder device 10 to the finished floor surface without the use of screw fasteners passing through the floor, thereby avoiding damage to the finished floor surface. The mounting adapter 40 includes a base plate 42 with a beveled top 43 around its perimeter and a bottom side 45. The bottom side is provided with a two way adhesive film, such as double-sided tape or a double-sided adhesive membrane that adheres to both the bottom side 45 and the underlying floor surface. The bottom of the adhesive tape or membrane is covered with a protective film that peels away at the time of installation to expose the bottom tacky adhesive surface of the membrane so that it can be attached to the floor surface.

The mounting adapter is also provided with male sleeves 44 that extend upwardly from the base plate 42. The male sleeves 44 are specifically sized, structured and configured for sliding receipt within congruently configured cavities on the underside of the doorstop and holder device 10. Thus, the male sleeves 44 insure that the doorstop and holder device 10 is placed squarely in position on the adapter 40 so that, once the device 10 is received on the adapter 40, the two components are held together as an integral unit. When received on the adapter 40, the doorstop and holder device 10 is prevented from twisting relative to the adapter 40. A screw post 46 extending upwardly from the base plate of the adapter is received within the lower portion of the bore 18 on the underside of the doorstop and holder device 10. A screw fastener can then be fitted through the top counter-sunk portion of bore 18 and fastened into the screw post 46 of the mounting adapter 40. This causes the screw post to expand within the lower portion of the counter-sunk bore 18, providing a tight friction fit. When the screw fastener is tightened down into the counter-sunk bore, the doorstop and holder device 10 is held tight onto the mounting adapter 40. Alternatively, screw fasteners can be fitted through the front and back ends of the device 10 and into the sleeves 44 of the adapter (see FIG. 5), to thereby securely fasten the doorstop and door holder device 10 to the mounting adapter 40.

When the doorstop and holder device 10 is no longer needed, the adapter 40 can be easily removed with a putty knife or other scraping tool which separates the adhesive without damaging the floor surface. A solvent can then be used on the floor surface to remove any adhesive residue.

While the present invention has been shown and described in accordance with preferred and practical embodiments thereof, it is recognized that departures from the instant disclosure are fully contemplated within the spirit and scope of the invention.

What is claimed is:

1. A doorstop and door holder device, comprising:
a base structured and disposed for mounting to a floor and including opposite sides each having an abutment face for impact with a door to stop movement of the door in a first direction;
a pair of oppositely disposed arms extending outwardly from the opposite sides of the base, each of said arms including a distal end portion with a head, and said head on each of said arms including a tapered frontal surface adapted for brushing engagement with the door as the door moves in the first direction toward the abutment face of one of the opposite sides of said base, and the head on each of said arms further including a rear surface defining a shoulder for captivating the door between the head and the abutment face of said base; and
said arms being structured and disposed to permit flexing movement for allowing the door to move past said head as the door brushes against the tapered frontal surface while the door is moving in the first direction, and said arms being further structured and disposed for flexing movement in response to an externally applied force in order to release the door from captivation between the head and the abutment face, thereby allowing movement of the door in a second direction away from said doorstop and door holder device.

2. The doorstop and door holder device as recited in claim 1 wherein said base includes a top side with an opening for passage of a screw fastener through said base and into the floor, thereby securely mounting the device to the floor.

3. The doorstop and door holder device as recited in claim 1 wherein the opposite sides of said base each include an area of first height and an area of second height, and said area of second height extending higher than said area of first height relative to the floor.

4. The doorstop and door holder device as recited in claim 1 further comprising a mounting adapter, said mounting adapter comprising:
a flat bottom surface for attachment to the floor; and
a top side for attachment to said base.

5. The doorstop and door holder device as recited in claim 4 wherein said top side of said mounting adapter is structured and disposed for mating receipt of said base.

6. The doorstop and door holder device as recited in claim 5 wherein said top side of said mounting adapter includes at least one upwardly extending member and an underside of said base includes at least one cavity, and said at least one upwardly extending member being sized, structured and configured for congruent receipt within said at least one cavity to discourage twisting, lateral, and horizontal movement of said base relative to said mounting adapter.

7. A doorstop and door holder device for stopping swinging movement of a door relative to a door opening and a floor surface, said device comprising:
a base structured and disposed for mounting to the floor surface and said base including opposite sides each having an abutment face for impact with the door to stop swinging movement of the door in a first direction;
a pair of oppositely disposed arms each extending outwardly from a respective one of the opposite sides of the base, and each of said arms including a distal end portion with a head; and
each of said arms being structured and disposed to yield to a sufficient force of the swinging door when the door is moving in the first direction so that the door moves past the head on the distal end portion of the respective arm and into abutting impact with the abutment face, and each of said arms being structured and disposed for releasably captivating the door between the head and the abutment face on a respective one of the opposite sides of the base, thereby stopping swinging movement of the door in an opposite second direction away from said base.

8. The doorstop and door holder device as recited in claim 7 wherein said heads on each of said arms include a tapered frontal surface adapted for brushing engagement with the swinging door as the door moves in the first direction toward the abutment face.

9. The doorstop and door holder device as recited in claim 8 wherein the heads on each of said arms further include a rear surface defining a shoulder for stopping swinging movement of the door in the second direction, thereby releasably captivating the door between the head and the abutment face of said base.

10. The doorstop and door holder as recited in claim 9 wherein said arms are structured and disposed to flex while yielding to a force exerted by the swinging door moving in the first direction as the door brushes against the tapered frontal surface.

11. The doorstop and door holder device as recited in claim 10 wherein said arms are structured and disposed to flex in yielding response to the force exerted by the swinging door when moving in the first direction to allow the swinging door to move past the head when a sufficient force is exerted by the swinging door against the tapered frontal surface of the head.

12. The doorstop and door holder device as recited in claim 11 wherein said arms are further structured and disposed for flexing movement in response to an externally applied force in order to release the door from captivation between the head and the abutment face, thereby allowing movement of the door in the second direction away from said base.

13. The doorstop and door holder device as recited in claim 7 wherein the opposite sides of said base each include an area of first height and an area of second height, and said area of second height extending higher than said area of first height relative to the floor surface.

14. The doorstop and door holder device as recited in claim 7 wherein said base includes a top side with an opening for passage of a screw fastener through said base and into the floor surface, thereby securely mounting the device to the floor surface.

15. The doorstop and door holder device as recited in claim 7 further comprising a mounting adapter, said mounting adapter comprising:
a bottom surface for attachment to the floor surface; and
a top side for attachment to said base.

16. The doorstop and door holder device as recited in claim 15 wherein said top side of said mounting adapter is structured and disposed for mating receipt of said base.

17. The doorstop and door holder device as recited in claim 16 wherein said top side of said mounting adapter includes at least one upwardly extending member and an underside of said base includes at least one cavity, and said at least one upwardly extending member being sized, structured and configured for congruent receipt within said at least one cavity to discourage twisting, lateral, and horizontal movement of said base relative to said mounting adapter.

18. A doorstop and door holder device for stopping swinging movement of a door relative to a door opening and a floor surface, said device comprising:
a base structured and disposed for mounting to the floor surface and said base including opposite sides each having an abutment face for impact with the door to stop swinging movement of the door in a first direction;
a pair of oppositely disposed arms each extending outwardly from a respective one of the opposite sides of the base, and each of said arms including a distal end portion with a head; and
each of said arms being structured and disposed to yield to a sufficient force of the swinging door when the door is moving in the first direction so that the door moves past the head on the distal end portion of the respective arm, and each of said arms being structured and disposed for releasably captivating the door between the head and the abutment face on a respective one of the opposite sides of the base.

19. The doorstop and holder device as recited in claim 18 further comprising a mounting adapter, said mounting adapter comprising:
a bottom surface for attachment to the floor surface; and
a top side for attachment to said base.

20. The doorstop and door holder device as recited in claim 19 wherein said top side of said mounting adapter is structured and disposed for mating receipt of said base.
